(19) United States
(12) Patent Application Publication
(10) Pub. No.: US 2015/0061503 A1
(43) Pub. Date: Mar. 5, 2015

(54) INTELLIGENT LIGHT EMITTING DIODE (LED) CONTROLLER AND DRIVER

(71) Applicant: enLighted, Inc., Sunnyvale, CA (US)

(72) Inventors: Michel Billard, Sunnyvale, CA (US); Tanuj Mohan, Mountain View, CA (US)

(73) Assignee: enLighted, Inc., Sunnyvale, CA (US)

(21) Appl. No.: 14/539,092

(22) Filed: Nov. 12, 2014

Related U.S. Application Data
(63) Continuation-in-part of application No. 13/930,009, filed on Jun. 28, 2013.
Application No. 13/930,009 is a continuation of application No. 12/849,081, filed on Aug. 3, 2010, now Pat. No. 8,508,149.
(60) Provisional application No. 61/912,633, filed on Dec. 6, 2013.

(51) Int. Cl. H05B 33/08

(52) U.S. Cl. CPC H05B 33/0845
USPC 315/149

(57) ABSTRACT

An apparatuses, methods, and systems of light emitting diode (LED) control are disclosed. One embodiment includes an LED control system that includes a sensor unit and a light emitting diode (LED) driver/controller unit. The sensor unit includes a sensor controller and a sensor, wherein the sensor is operative to generate a sensed signal based on at least one of sensed motion or light. The LED driver/controller unit includes an LED driver, and an LED controller. At least one of the sensor controller and the LED controller is operative to generate dimming control of an LED based on at least one of the sensed signal and communication from a network, and adjust a dimming of the LED based on the dimming control.

### RELATED APPLICATIONS

This patent application claims priority to Provisional Patent Application 61/912,633, filed Dec. 6, 2013, and is a continuation-in-part (CIP) of U.S. patent application Ser. No. 13/930,009, filed Jun. 28, 2013, which is a continuation patent application of U.S. patent application Ser. No. 12/849,081, filed Aug. 3, 2010, and granted as U.S. Pat. No. 8,508,149, all of which are herein incorporated by reference.

### FIELD OF THE EMBODIMENTS

The described embodiments relate generally to lighting. More particularly, the described embodiments relate to a light emitting diode (LED) fixture and providing the light fixture with intelligence.

### BACKGROUND

Lighting control can be used to automatically control lighting under certain conditions, thereby conserving power. However, lighting control, specifically advanced lighting controls have not been widely adopted in the general commercial market because the installation, setup related costs and complexity have made these lighting systems prohibitively expensive for most commercial customers. Additionally, if these systems include intelligence, they are centrally controlled.

It is desirable to have a lighting method, system and apparatus for distributed intelligent lighting that is easy to install and is cost effective.

### SUMMARY

One embodiment includes an LED control system that includes a sensor unit and a light emitting diode (LED) driver/controller unit. The sensor unit includes a sensor controller and a sensor, wherein the sensor is operative to generate a sensed signal based on at least one of sensed motion or light. The LED driver/controller unit includes an LED driver, and an LED controller. At least one of the sensor controller and the LED controller is operative to generate dimming control of an LED based on at least one of the sensed signal and communication from a network, and adjust a dimming of the LED based on the dimming control.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1A and FIG. 1B show examples of a prior art light fixtures.

FIG. 2 shows an example of an LED fixture that includes intelligence, according to an embodiment.

FIG. 3 shows another example of an LED fixture that includes intelligence according to another embodiment.

FIG. 4 is a flow chart that includes steps of an example of a method of retrofitting an LED fixture, according to an embodiment.

FIG. 5 shows another example of an LED fixture that includes intelligence according to another embodiment.

### DETAILED DESCRIPTION

The described embodiments are embodied in apparatuses and methods for a light emitting diodes (LED) fixture that includes intelligence. The light fixture allows for intelligent control of the light of the LED fixture. For at least some embodiments, the light fixture is networked with other light fixtures allowing for distributed control of multiple light fixtures. Additionally, for at least some embodiments of the LED fixtures include network interfaces for additional or alternative light control.

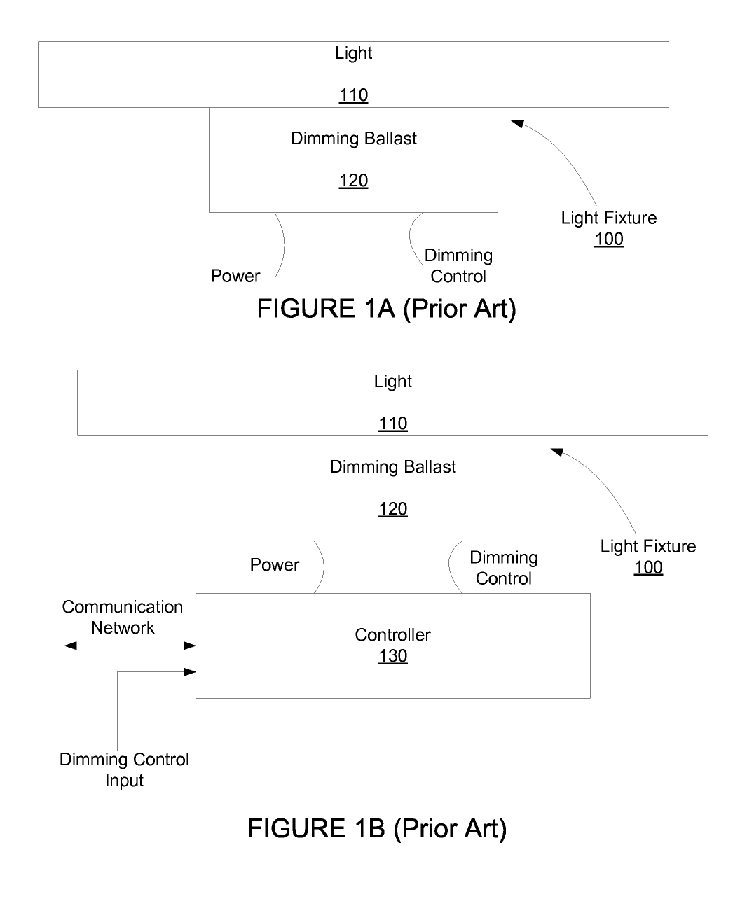

FIG. 1A shows an example of a prior art light fixture 100. The light fixture 100 includes a light 110, and a dimming ballast 120. As shown, the dimming ballast 120 receives a power input and a dimming control input, and provides a regulated current to the light 110.

The light 110 can be a gas-discharge lamp, which is typically negative-resistance device. Such devices cannot effectively regulate their current use. If such a device were connected to a constant-voltage power supply, it would draw an increasing amount of current until it was destroyed or caused the power supply to fail. To prevent this, a ballast (such as the dimming ballast 120) provides a positive resistance that limits the ultimate current to an appropriate level. In this way, the ballast provides for the proper operation of the negative-resistance device by appearing to be a legitimate, stable resistance in the circuit.

As shown, the lighting fixture 100 has no intelligence. The lighting fixture 100 receives all lighting control, which includes power and dimming of the light of the light fixture.

FIG. 1B shows an example of another prior art light fixture 100. The light fixture 100 includes a light 110, a dimming ballast 120, and a controller 130. The controller 130 is operative to receive inputs from a network, or directly from a dimming control input. As shown, the dimming ballast 120 receives a power input and a dimming control input, and provides a regulated current to the light 110.

The light fixture may include a controller 130, but has no intelligence regarding control of the light 110. That is, the network may direct the controller 130 as to how to control the light 110, but the controller 130 does not make its own dimming control decisions. The controller 130 can also directly receive dimming control, but again, the controller 130 does not make its own dimming control decisions.

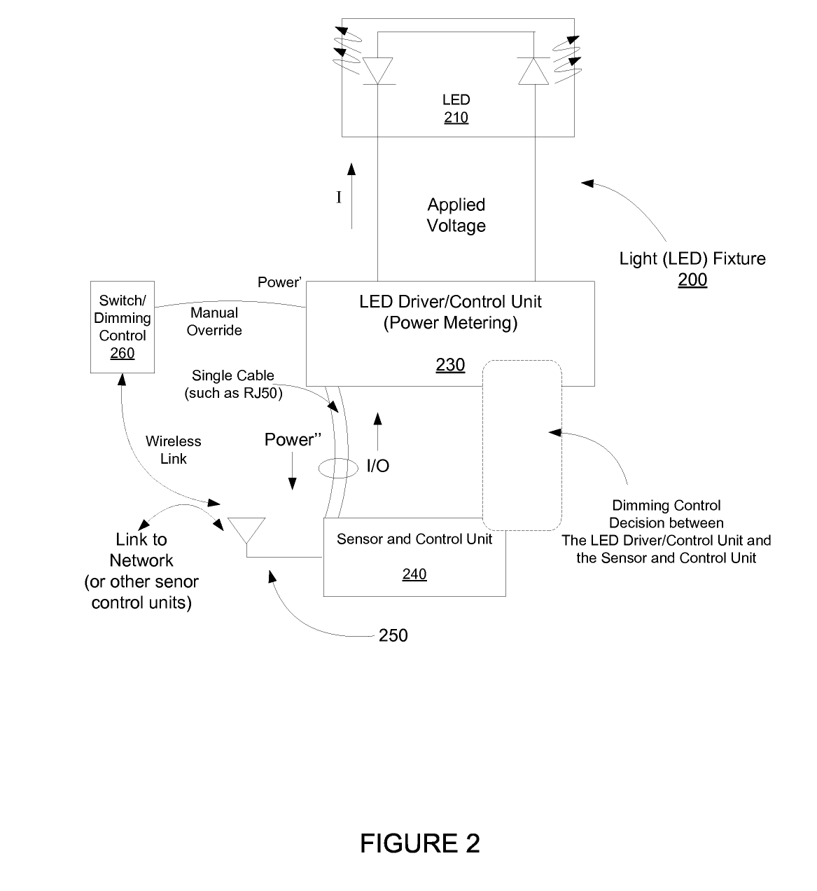

FIG. 2 shows an example of an LED fixture 200 that includes intelligence, according to an embodiment. More specifically, an LED Driver/Control Unit 230 is connected to an LED 210, and provides a control signal (I) for controlling the intensity of light emitted from the LED 210. Additionally, a sensor unit 240 is connected to the LED Driver/Control Unit 230.

For an embodiment, the LED Driver/Control Unit 230 provides power to the sensor unit 240, and the sensor unit 240 provides control signals to the LED Driver/Control Unit 230. This embodiment further includes a communications link being established between the sensor unit 240 and a network or other devices. Rather than being connected to the network, the sensor unit can connect to other sensor units and LED Driver/Control Units, allowing for decentralized control of a plurality of light fixtures. For a specific embodiment, the sensor unit 240 includes at least one antenna 250 and is wirelessly linked (through, for example, BLUETOOH® or ZIGBEE®) to the network, or other devices.

The wireless link can advantageously be located within the sensor unit 240 rather than within the LED Driver/Control Unit 230 because at least some embodiments include the LED Driver/Control Unit 230 being located within a common metal enclosure as the LED 210 of the light (LED) fixture 200. For these embodiments, locating the wireless link within the LED Driver/Control Unit 230 subjects the wireless link to attenuation cause by the metal enclosure. By locating the antenna proximate to, but outside of the metal enclosure of the light fixture 100, the quality of the wireless link can be sustained. That is, by locating the wireless link of the antenna 250 with the sensor unit 240 (which is located outside of the metal enclosure) the wireless link of the antenna 250 is for at least some embodiments, also located outside of the common metal enclosure of the light (LED) fixture 200

For an embodiment, the conductor providing power from the LED Driver/Control Unit 230 to the sensor unit 240, and the conductor(s) providing control signal(s) from the sensor unit 240 to the LED Driver/Control Unit 230 are located in a common cable. For an embodiment, the voltage provided to power the sensor unit 240 is, for example, a low-power DC voltage. Being a low voltage, the sensor unit 240 can be connected, and re-connected to the LED Driver/Control Unit 230 by a lay-person (that is, a skilled, high-cost technician is not required for deploying the LED lighting system). That is, the voltage supply is low enough that, for example, replacement of the sensor unit is safe enough that an electrician is not required to make the replacement. For an embodiment, the sensor unit 240 is attached to a ceiling proximate to the LED Driver/Control Unit 230. The cable allows for easy installation of the retrofit LED Driver/Control Unit 230 and retrofit sensor unit 240. Exemplary cables include a cable with a RJ-45, RJ-50 like connector at either end. Flat cables can be desirable because that can easily slip easily between a guide-rail and a ceiling tile of a typical industrial ceiling, without requiring a hole in the tile.

Embodiments include all of the LED processing based on the sensed signals and any network input occurring all or partially within the sensor unit 240. Other embodiments include varying amount of the driver control processing occurring within the LED Driver/Control Unit 230. As indicated in FIG. 2, the dimming control decisions can be distributed between the LED Driver/Control Unit 230 and the sensor unit 240.

A manual switch, dimming control or timing dimming control unit 260 can provide manual dimming control. Dimming control can be transferred from automated control provided by the LED Driver/Control Unit 230 and the sensor unit 240, to manual control provided by the dimming control unit 260, by the dimming control unit 260 communicating a transfer of control. The transfer of control can be communicated, for example, by the dimming control unit 260 cycling power supplied by the dimming control unit 260 according to a predetermined sequence. For example, the predetermined sequence can include manually power cycling by the dimming control unit 260 three times within a predetermined amount of time. If the LED Driver/Control Unit 230 and the sensor unit 240 combination receives the power cycling according to the predetermined sequence (three cycles) then the manual over-ride is invoked, and the dimming control unit 260 provides manual control until, for example, another sequence transfers dimming control back to the LED Driver/Control Unit 230 and the sensor unit 240 combination. Once in manual mode, the sensed signals no longer influence the dimming control.

Though not shown, it is to be understood that for an embodiment, the switch/dimming control 260 is provided by a mobile device (such as, a remote control, smart phone or other mobile computing device), and is electromagnetically connected to the antenna 250 rather than directly to the LED Driver/Control unit 230. That is, for example, for an embodiment, the switch/dimming control 260 is wirelessly connected (through, for example, BLUETOOH® or ZIGBEE®) to the sensor unit 240 through the antenna 250.

An existing light fixture can be upgraded as shown in FIG. 2 without having to modify or update existing electrical wiring and switches. This is very desirable because the upgrade is easy, fast and inexpensive to implement. Once upgraded, many light fixtures can be managed with decentralized control. Decentralized control is desirable over centralized control because there is not a single point of failure. A purchaser of the retrofit kits can upgrade existing light fixtures over time.

The sensor and control unit 240 includes sensors that sense conditions that are used for controlling the intensity of light emitted from the LED 210. Such sensed signals include at least one of motion, light, temperature, images, etc. It is to be understood that this is not an exhaustive list of possible sensed conditions.

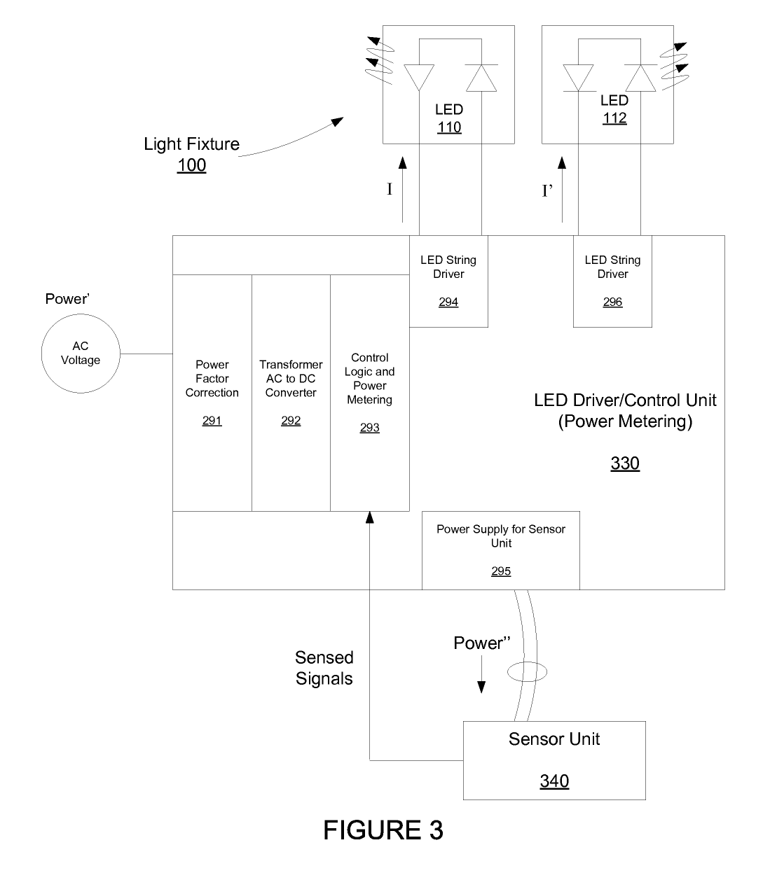

FIG. 3 shows another example of LED fixture that includes intelligence, according to another embodiment. As shown, LEDs 110, 112 are connected to the LED Driver/Control Unit 330. Further, the sensor unit 340 is connected to the LED Driver/Control Unit 330.

FIG. 3 provides additional detail of an embodiment. More specifically, the LED Driver/Control Unit 330 includes a power factor correction circuit 291, an AC to DC transformer 292, a Power Supply for Sensor Unit 295, and control logic and power metering circuitry 293.

The power factor correction circuit 291 receives AC voltage power, and adjusts the phase of the received AC voltage. The power factor correction circuit 291 provides power factor correction.

The AC to DC transformer 292 converts the received AC voltage to a DC voltage which is useable by the rest of the LED Driver/Control Unit 330 and the sensor unit 340. The Power Supply for Sensor Unit 295 provides a low-power voltage to the sensor unit 340.

The control logic and power metering circuitry 293 amongst other things, receives sensed signals from the sensor unit 340. For an embodiment, the control logic and power metering circuitry 293 generates LED driver control signals for controlling an intensity of light of the LEDs 110, 112 based on the LED driver control signals.

As shown, LED string drivers 294, 296 receive the LED driver control signals and generate current drive signals (I, I′) for controlling the intensity of light emitted from the LEDs 110, 112.

For an embodiment, the LED Driver/Control Unit 330 also monitors the power consumed by the LED Driver/Control Unit 330, the sensor unit 340 and the LEDs 110, 112.

An embodiment includes a lighting fixture retrofit kit. The retrofit kit includes a sensor unit, a dimming controller and an electrical cable. The retrofit kit when purchased can be used to retrofit a “non-intelligent” light fixture as shown in FIG. 1, to be an “intelligent” light fixture as shown in FIG. 2. Embodiments of the sensor unit include one or more sensors. The sensors can include, for example, a light sensor, a motion sensor and/or a temperature sensor. When functioning, the sensor is operative to generate a sensed signal base on, for example, sensed motion, light and/or temperature. The sensor unit additionally includes wireless communication circuitry. When activated, the wireless communication circuitry is operative to maintain a wireless link (for example, Bluetooth) with a network. The sensor unit additionally includes a controller, wherein the controller is operative to manage communication with the network, and to generate dimming control base on at least one of the sensed signal and communication from the network. The dimming controller include means for receiving the dimming control from the sensor unit, and is operative to adjust a dimming control line to a light.

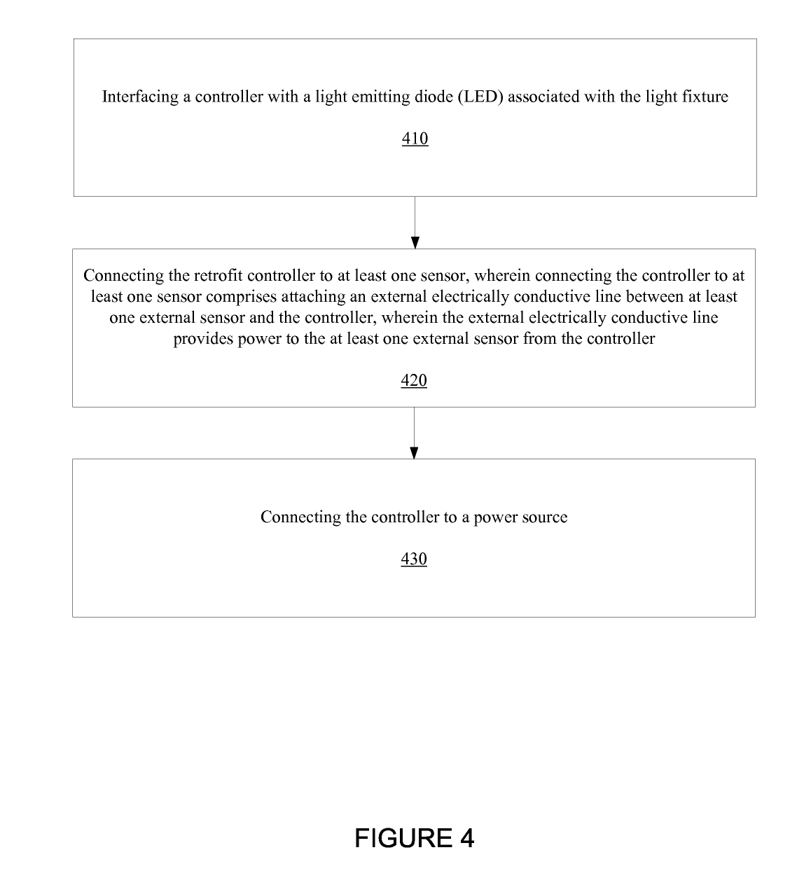

FIG. 4 is a flow chart that includes steps of an example of a method of retrofitting a light fixture. A first step 410 includes interfacing a controller with a light emitting diode (LED) associated with the light fixture. A second step 420 includes connecting the retrofit controller to at least one sensor, wherein connecting the controller to at least one sensor comprises attaching an external electrically conductive line between at least one external sensor and the controller, wherein the external electrically conductive line provides power to the at least one external sensor from the controller. A third step 430 includes connecting the controller to a power source.

At least one embodiment further includes affixing the at least one external sensor proximate to the light fixture. For at least one embodiment, the external electrically conductive line provides at least one of sensor and control information from the at least one external sensor to the retrofit controller.

For at least one embodiment, the at least one external sensor includes a second controller, and the at least one external sensor being wirelessly connected to a network. For at least one embodiment, the at least one external sensor provides dimming control information to the controller based on at least one of sensed information and control information received from the network.

For at least one embodiment, the controller receives sensed information from the at least one sensor, and adaptively controls dimming of the LED based on the sensed information.

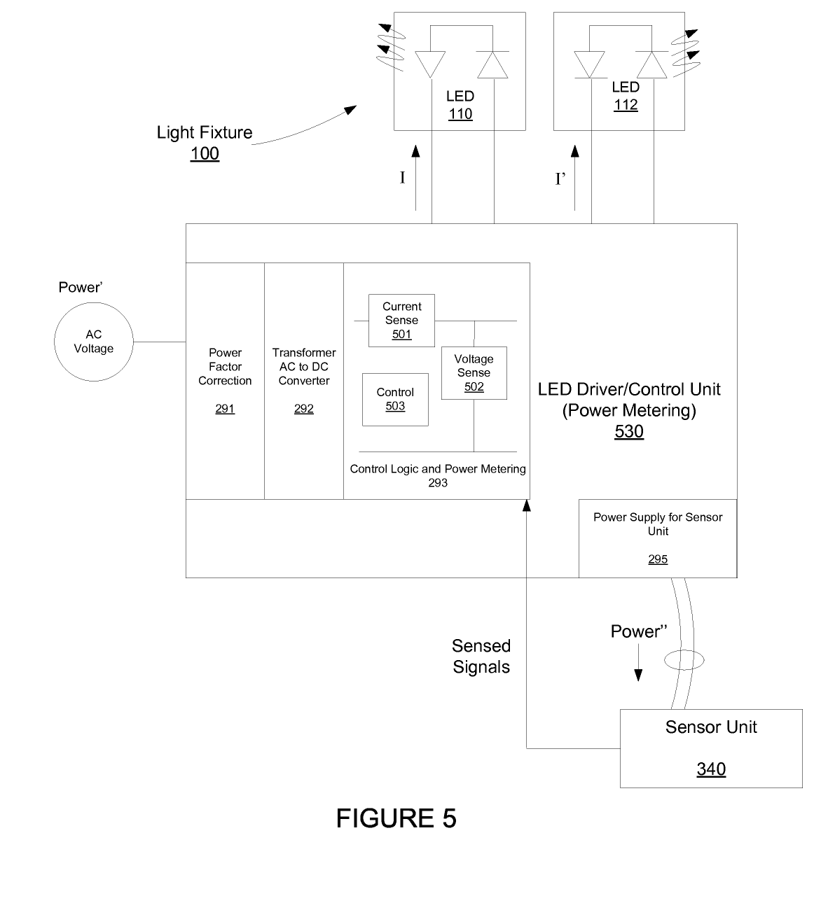

FIG. 5 shows another example of an LED fixture that includes intelligence according to another embodiment. This embodiment shows additional detail of an embodiment of the control logic and power metering circuitry 293. As shown, for this embodiment, the control logic and power metering circuitry 293 includes a current sensor 501 that senses current conducted by the LED Driver/Control Unit 530, and a voltage sensor 502 that senses the voltage applied to the LED Driver/Control Unit 530. Control logic and processing 503 associated with the control logic and power metering circuitry 293 provides for monitoring of the current sensed by the current sensor 501 and the monitoring of the voltage sensed by the voltage sensor 502.

At least some embodiments include processing of the sensed current and the sensed voltage of the control logic and power metering circuitry 293. For example, for an embodiment, the power used by the LED Driver/Control Unit 530 is monitored over time. For an embodiment, the power metering unit is operative to monitoring power consumed by the sensor unit and the LED driver/controller unit. For an embodiment, the power metering unit 293 is further operative to monitor active power, reactive power, a power factor, voltage, and energy associated with the sensor unit and the LED driver/controller unit.

For at least some embodiments, usage patterns of a user of one of more LED Fixtures are monitored, observed and analyzed based on the monitored power consumption. For an embodiment, at least one of the sensor controller and the LED controller is operative to aid in generation of statistics of power consumption of the sensor unit and the LED driver/controller unit. Further, for an embodiment, at least one of the sensor controller and the LED controller is operative to report at least a portion of the statistics of power consumption of the sensor unit and the LED driver/controller unit to an external controller.

For at least some embodiments, at least one of the sensor controller and the LED controller is operative to receive a power demand response, and the monitored power consumption provides an indicator of whether the LED fixtures or LED fixtures are adhering to the power demand response.

For at least some embodiments, at least one of the sensor controller and the LED controller is operative to determine an operating health of the LED fixture by comparing a sensed level of light emitted from the LED 210 with the monitored power consumption provides of the LED 210. That is, if the light emitted from the LED 210 is low, but the power consumed by the LED fixture is high, then a failure of the LED fixture can be determined. The sensed level of light emitted from the LED 210 can be determined from a light sensor of the sensor and control unit 240.

Although specific embodiments have been described and illustrated, the described embodiments are not to be limited to the specific forms or arrangements of parts so described and illustrated. The embodiments are limited only by the appended claims.

What is claimed:

1. An LED control system comprising:
a sensor unit;
and a light emitting diode (LED) driver/controller unit; wherein
the sensor unit comprises;
a sensor, the sensor operative to generate a sensed signal based on at least one of sensed motion or light; and
a sensor controller;
and wherein the LED driver/controller unit comprises;
an LED driver;
an LED controller;
wherein at least one of the sensor controller and the LED controller is operative to:
generate dimming control of an LED based on at least one of the sensed signal and communication from a network; and
wherein the LED driver adjusts a dimming of the LED based on the dimming control.

2. The light fixture of claim 1, further comprising an electrical cable for providing electrical power from the LED driver/controller unit to the sensor unit, and providing control lines between the sensor unit to the LED driver and controller unit.

3. The light fixture of claim 1, further comprising the LED driver/controller unit operative to identify a sequence of power cycling, and transferring dimming control to a manual switch when a predetermined sequence of power cycling is received.

4. The light fixture of claim 1, wherein the LED driver/controller unit further comprises a power metering unit, wherein the power metering unit is operative to monitoring power consumed by the sensor unit and the LED driver/controller unit.

5. The light fixture of claim 4, wherein the power metering unit is further operative to monitor active power, reactive power, a power factor, voltage, and energy associated with the sensor unit and the LED driver/controller unit.

6. The light fixture of claim 5, wherein at least one of the sensor controller and the LED controller is operative to aid in generation of statistics of power consumption of the sensor unit and the LED driver/controller unit.

7. The light fixture of claim 5, wherein at least one of the sensor controller and the LED controller is operative to report at least a portion of the statistics of power consumption of the sensor unit and the LED driver/controller unit to an external controller.

8. The light fixture of claim 1, wherein the LED driver/controller unit provides a low voltage to the sensor unit.

9. The light fixture of claim 1, wherein the LED driver and controller unit provides a driver current to the LED.

10. The light fixture of claim 1, wherein the LED driver and controller unit controls dimming of the LED by pulse width modulation the driver current to the LED.

11. A method of operating a light fixture, comprising:
interfacing an LED driver/controller unit with one or more light emitting diodes (LEDs);
connecting the LED driver/controller unit to a sensor unit; and
connecting the LED driver/controller unit to a power supply, wherein the LED driver/controller unit provides low-power to the sensor unit, and power to the one or more LEDs.

12. The method of claim 11, further comprising monitoring power consumed by the LED driver and controller unit and the sensor unit.

13. The method of claim 11, further comprising connecting the LED driver and controller unit to a network through the sensor unit.

14. The method of claim 11, further comprising connecting the LED driver and controller unit to a network through a power line.

15. A method of retrofitting a light fixture, comprising:
interfacing a controller with a light emitting diode (LED) associated with the light fixture;
connecting the controller to at least one sensor; and
connecting the controller to a power source;
wherein connecting the controller to at least one sensor comprises attaching an external electrically conductive line between at least one external sensor and the controller; and
wherein the external electrically conductive line provides power to the at least one external sensor from the controller.

16. The method of claim 15, further comprising affixing the at least one external sensor proximate to the light fixture.

17. The method of claim 15, wherein the external electrically conductive line provides at least one of sensor and control information from the at least one external sensor to the retrofit controller.

18. The method of claim 17, further comprising the at least one external sensor comprising a second controller, and the at least one external sensor being wirelessly connected to a network.

19. The method of claim 18, further comprising the at least one external sensor providing dimming control information to the controller based on at least one of sensed information and control information received from the network.

20. The method of claim 15, further comprising the controller receiving sensed information from the at least one sensor, and adaptively controlling dimming of the LED based on the sensed information.

21. The method of claim 20, wherein the sensed information comprises a combination of sensed light, sensed motion, and sensed temperature.

22. The method of claim 15, further comprising the controller receiving control information from other retrofit controllers over a network.

23. The method of claim 15, further comprising providing a manual over-ride, allowing manual input control of dimming control of the LED utilizing an existing dimming control mechanism.
